(19) United States
(12) Patent Application Publication
(10) Pub. No.: US 2008/0315783 A1
(43) Pub. Date: Dec. 25, 2008

(54) ILLUMINATION LIGHT EMITTING ELEMENT AND ILLUMINATION DEVICE PROVIDED THEREWITH

(76) Inventor: Katsumi INABA, Osaka (JP)

Correspondence Address: BIRCH STEWART KOLASCH & BIRCH, PO BOX 747, FALLS CHURCH, VA, 22040-0747, US

(21) Appl. No.: 12/134,926

(22) Filed: Jun. 6, 2008

(30) Foreign Application Priority Data
Jun. 20, 2007 (JP) 2007-162453

(51) Int. Cl. H05B 37/02

(52) U.S. Cl. 315/247

(57) ABSTRACT

An illumination light emitting element driving circuit includes a power factor improving circuit (2). The power factor improving circuit (2), when a load (illumination light emitting diode 17) of the illumination light emitting element driving circuit is light, performs operation (including stopping the operation) different from operation performed when the load is not light to thereby make power consumption lower than power consumption during the operation performed when the load is not light.

This nonprovisional application claims priority under 35 U.S.C. §119(a) on Patent Application No. 2007-162453 filed in Japan on Jun. 20, 2007, the entire contents of which are hereby incorporated by reference.

### BACKGROUND OF THE INVENTION

The present invention relates to an illumination light emitting element driving circuit and an illumination device provided therewith.

### DESCRIPTION OF RELATED ART

As a conventional illumination light emitting element driving circuit, an illumination light emitting diode driving circuit for driving an illumination light emitting diode will be described here as an example. FIG. 9 shows one configuration example of the conventional illumination light emitting diode driving circuit.

The conventional illumination light emitting diode driving circuit shown in FIG. 9 is composed of: a constant voltage output switching power supply circuit: and a constant current output switching power supply circuit that supplies a constant current to an illumination light emitting diode 17 by using a voltage outputted by the constant voltage output switching power supply circuit as a driving voltage.

The constant voltage output switching power supply circuit includes: a full-wave rectifying circuit 1, a power factor improving circuit 2′, a smoothing capacitor 3, a transformer 4, an N-channel MOSFET 5, a control circuit 6 for performing on-off control of the N-channel MOSFET 5, a diode 7, a capacitor 8, resistors 9 and 10, a shunt regulator 11, and a photo coupler 12.

The constant current output switching power supply circuit includes: a driver 13, a diode 14, a coil 15, a capacitor 16, and a current setting resistor 18 serially connected to the illumination light emitting diode 17.

An AC voltage inputted to the constant voltage output switching power supply circuit first goes through full-wave rectification by the full-wave rectifying circuit 1, passes through the power factor improving circuit 2′, and then is smoothened by the smoothing capacitor 3. A voltage across the smoothing capacitor 3 is applied to a serially connected body composed of a primary wire of the transformer 4 and the N-channel MOSFET 5 and to the control circuit 6. Energy is stored in the primary wire of the transformer 4 when the N-channel MOSFET 5 is on, while the energy stored in the primary wire of the transformer 4 is released to a secondary wire of the transformer 4 when the N-channel MOSFET 5 is off. The control circuit 6 performs the on-off control of the N-channel MOSFET 5 in accordance with an output of the photo coupler 12. More specifically, the control circuit 6 turns off the N-channel MOSFET 5 when the photo coupler 12 is on and turns on the N-channel MOSFET 5 when the photo coupler 12 is off.

A voltage generated in the secondary wire of the transformer 4 is rectified by the diode 7, smoothened by the capacitor 8, and turns into an output voltage of the constant voltage output switching power supply circuit. The resistors 9 and 10 divides the output voltage of the constant voltage output switching power supply circuit, and supplies the divided voltage to a reference terminal of the shunt regulator 11. When the voltage supplied to the reference terminal of the shunt regulator 11 exceeds a threshold value, the shunt regulator 11 turns into a conducted state, and the photo coupler 12 is turned on accordingly.

The driver 13 turns on and off a switching element (not shown) located therein. When the switching element is on, a current flows from the driver 13 to the coil 15, whereby energy is stored into the coil 15 and also the current is supplied to the illumination light emitting diode 17. On the other hand, when the switching element is off, the energy stored in the coil 15 is released via the diode 14, whereby the current is supplied to the illumination light emitting diode 17. The driver 13 feeds back voltage drop at the current setting resistor 18, and controls the duty of the switching element in accordance with the voltage drop at the current setting resistor 18. As a result, the current flowing to the illumination light emitting diode 17 is set at a constant value in accordance with a resistance value of the current setting resistor 18.

An illumination device is required to comply with Class C of higher harmonic wave regulations. To satisfy a regulated value of this Class C, the illumination device is typically provided with a power factor improving circuit. However, providing the illumination device with the power factor improving circuit has resulted in a disadvantage that the current consumption increases for the power factor improving circuit

JP-A-2001-333573 refers to a reduced-voltage protection circuit of a power factor improving power supply that stops a power not only simply by a reduced voltage of a commercial AC power source but in combination with a state of an outputted load. This reduced voltage protection circuit is designed to be capable of operating without stopping when the output is a light load, but does not overcome the disadvantage that the current consumption increases for the power factor improving circuit.

JP-A-2007-80771 refers to an illumination power supply circuit functioning to feed back a current flowing through a load thereof to a step-down power factor control circuit so that the step-down power factor control circuit limits the current flowing through the load. This illumination power supply circuit needs not to be provided with a separate circuit for limiting the current flowing through the load, but does not overcome the disadvantage that the power consumption increases for the power factor improving circuit.

### SUMMARY OF THE INVENTION

It is an object of the present invention to provide an illumination light emitting element driving circuit capable of suppressing unnecessary power consumption and an illumination device provided therewith.

To achieve the object described above, according to one aspect of the invention, an illumination light emitting element driving circuit includes a power factor improving circuit. The power factor improving circuit, when a load of the illumination light emitting element driving circuit is light, performs operation (including stopping the operation) different from operation performed when the load of the illumination light emitting element driving circuit is not light to thereby lower power consumption (hereinafter also referred to as first configuration).

When the load is light, a harmonic current is small, which permits conformity with Class C of the higher harmonic wave regulations even without operating the power factor improving circuit normally. Thus, operating the power factor improving circuit normally when the load is light as in the conventional illumination light emitting diode driving circuit as shown in FIG. 9 results in unnecessary power consumption at the power factor improving circuit. On the other hand, in the illumination light emitting element driving circuit with the first configuration described above, the power factor improving circuit, when the load of the illumination light emitting element driving circuit is light, performs operation (including stopping the operation) different from operation performed when the load of the illumination light emitting element driving circuit is not light to thereby make the power consumption lower than power consumption during the operation performed when the load is not light, which permits suppressing the unnecessary power consumption.

Moreover, the following are more detailed configuration examples of the aforementioned illumination light emitting element driving circuit with the first configuration described above, which, “when the load of the illumination light emitting element driving circuit is light, performs operation (including stopping the operation) different from operation performed when the load of the illumination light emitting element driving circuit is not light”. A bypass part is further provided which bypasses the power factor improving circuit when the load of the illumination light emitting element driving circuit is light, and the power factor improving circuit stops the operation when the load of the illumination light emitting element driving circuit is light (hereinafter, referred to as second configuration). The power factor improving circuit includes: a switching transistor; and a control circuit performing series control of the switching transistor when the load of the illumination light emitting element driving circuit is light and performing switching control of the switching transistor when the load of the illumination light emitting element driving circuit is not light (hereinafter, referred to as third configuration). The power factor improving circuit includes: a switching transistor; and a control circuit intermittently performing switching control of the switching transistor when the load of the illumination light emitting element driving circuit is light and constantly performing the switching control of the switching transistor when the load of the illumination light emitting element driving circuit is not light (hereinafter, referred to as fourth configuration). The power factor improving circuit includes: a switching transistor; and a control circuit, when the load of the illumination light emitting element driving circuit is light, as compared to when the load of the illumination light emitting element driving circuit is not light, lowering a switching frequency in switching control of the switching transistor (hereinafter, referred to as fifth configuration). The power factor improving circuit includes: a switching transistor; and a control circuit, when the load of the illumination light emitting element driving circuit is light, as compared to when the load of the illumination light emitting element driving circuit is not light, lowering a switching speed of the switching transistor in switching control of the switching transistor (hereinafter, referred to as sixth configuration).

In the illumination light emitting element driving circuit according to any of the first to sixth configurations may further include a judgment part detecting a current flowing through the load of the illumination light emitting element driving circuit and judging whether or not the load of the illumination light emitting element driving circuit is light. The power factor improving circuit may perform operation (including stopping the operation) in accordance with a result of the Judgment by the judgment part.

The illumination light emitting element driving circuit according to any of the first to sixth configurations, may include: a constant voltage output switching power supply circuit of an AC input type having the power factor improving circuit and a switching element and outputting a predetermined DC voltage by duty control of the switching element; and a constant current output switching power supply circuit supplying a constant current to an illumination light emitting element by using the voltage outputted by the constant voltage output switching power supply circuit as a driving voltage. The illumination light emitting element driving circuit may further include a judgment part detecting an input AC current of the constant voltage output switching power supply circuit and judging whether or not the load of the illumination light emitting element driving circuit is light. The power factor improving circuit may perform operation (including stopping the operation) in accordance with a result of the judgment by the judgment part.

The illumination light emitting element driving circuit according to any of the first to sixth configurations may include: a constant voltage output switching power supply circuit of an AC input type having the power factor improving circuit and a switching element and outputting a predetermined DC voltage by duty control of the switching element; and a constant current output switching power supply circuit supplying a constant current to an illumination light emitting element by using the voltage outputted by the constant voltage output switching power supply circuit as a driving voltage. The illumination light emitting element driving circuit may further include a judgment part detecting a current flowing through the switching element and judging whether or not the load of the illumination light emitting element driving circuit is light. The power factor improving circuit may perform operation (including stopping the operation) in accordance with a result of the judgment by the judgment part. The illumination light emitting element driving circuit may further include a judgment part detecting an amount of light of the illumination light emitting element driving circuit and judging whether or not the load of the illumination light emitting element driving circuit is tight. The power factor improving circuit may perform operation (including stopping the operation) in accordance with a result of the judgment by the judgment part.

The illumination light emitting element driving circuit according to any of the first to sixth configurations may further include a judgment part receiving an external signal and judging based on the external signal whether or not the load of the illumination light emitting element driving circuit is light. The power factor improving circuit may perform operation (including stopping the operation) in accordance with a result of the judgment by the judgment part.

To achieve the object described above, according to another aspect of the invention, an illumination device comprises the illumination light emitting element driving circuit according to any of the configurations described above.

With the illumination light emitting element driving circuit and an illumination device provided therewith, when a load is light, the power factor improving circuit performs operation (including stopping the operation) different from operation performed when the load is not light to thereby reduce the power consumption, which permits suppressing the power consumption.

### BRIEF DESCRIPTION OF THE DRAWINGS

FIG. 1 is a diagram showing configuration of an illumination light emitting diode driving circuit according to a first embodiment of the present invention;

FIG. 2 is a diagram showing configuration of an illumination light emitting diode driving circuit according to a second embodiment of the invention;

FIG. 3 is a diagram showing configuration of an illumination light emitting diode driving circuit according to a third and a fifth embodiments of the invention;

FIG. 4 is a diagram showing configuration of an illumination light emitting diode driving circuit according to a fourth and a sixth embodiments of the invention;

FIG. 5 is a diagram showing configuration of an illumination light emitting diode driving circuit according to a seventh embodiment of the invention;

FIG. 6 is a diagram showing configuration of an illumination light emitting diode driving circuit according to an eighth embodiment of the invention;

FIG. 7 is a diagram showing configuration of an illumination light emitting diode driving circuit according to a ninth embodiment of the invention;

FIG. 8 is a diagram showing configuration of an illumination light emitting diode driving circuit according to a tenth embodiment of the invention; and

FIG. 9 is a diagram showing one configuration example of a conventional illumination light emitting diode driving circuit.

### DETAILED DESCRIPTION OF PREFERRED EMBODIMENTS

The embodiments of the present invention will be described with reference to the accompanying drawings. As an example of an illumination light emitting element driving circuit according to the invention, an illumination light emitting diode driving circuit driving an illumination light emitting diode will be described here.

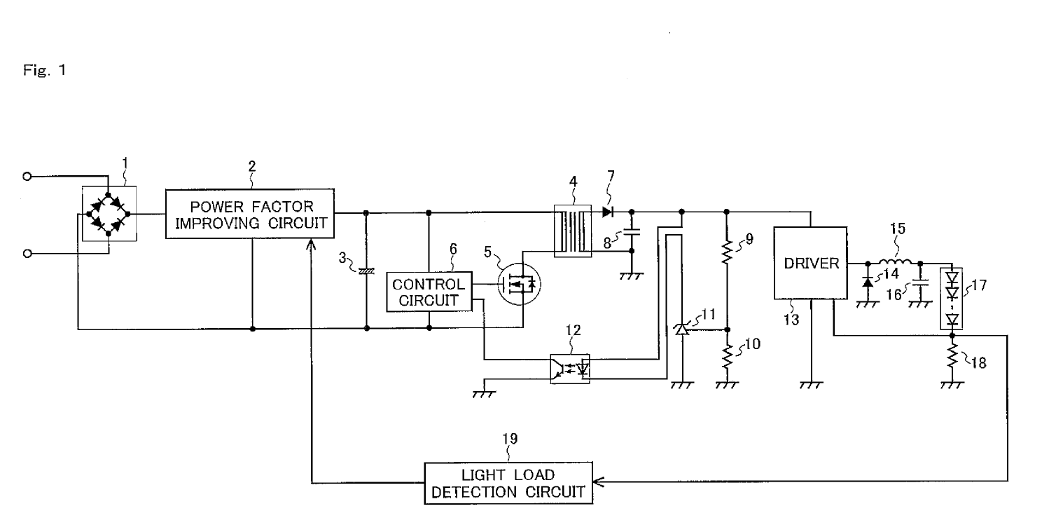

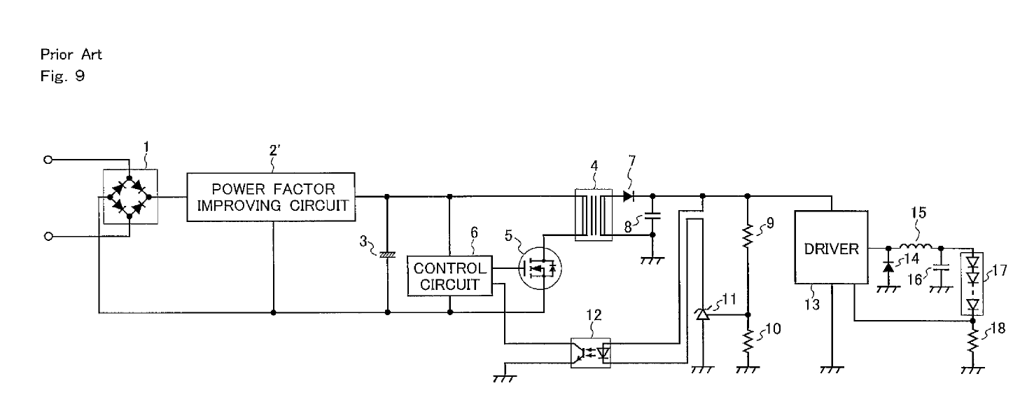

First, the first embodiment of the invention will be described. FIG. 1 shows configuration of an illumination light emitting diode driving circuit according to the first embodiment of the invention. In FIG. 1, portions the same as those in FIG. 9 are provided with the same numerals and thus omitted from detailed description.

The illumination light emitting diode driving circuit according to the first embodiment of the invention replaces the power factor improving circuit 2′ of the conventional illumination light emitting diode driving circuit shown in FIG. 9 with a power factor improving circuit 2 and is further newly provided with a light load detection circuit 19.

The light load detection circuit 19 receives a light load detection signal, judges based on this light load detection signal whether or not a load is light, and outputs a result of this judgment. In this embodiment, the light load detection signal represents voltage drop at a current setting resistor 18 and is a signal in accordance with a current flowing through an illumination light emitting diode 17. The light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

The power factor improving circuit 2 is a power factor improving circuit which can receive a result of the judgment by the light load detection circuit 19, and which, when the judgment result shows that the load is light, performs operation (including stopping the operation) different from operation performed when the load is not light to thereby make the power consumption in the power factor improving circuit 2 lower than power consumption during the operation performed when the load is not light.

When the load is light, a harmonic current is small, which permits conformity with Class C of the higher harmonic wave regulations even without operating the power factor improving circuit normally. Thus, operating the power factor improving circuit normally when the load is light as in the conventional illumination light emitting diode driving circuit as shown in FIG. 9 results in unnecessary power consumption at the power factor improving circuit. On the other hand, in the illumination light emitting diode driving circuit according to the first embodiment of the invention, the power factor improving circuit 2 receives the result of the judgment by the light load detection circuit 19, and when the judgment result shows that the load is light, performs operation different from operation performed when the load is not light to thereby make the power consumption lower than power consumption during the operation performed when the load is not light, which permits suppressing the unnecessary power consumption.

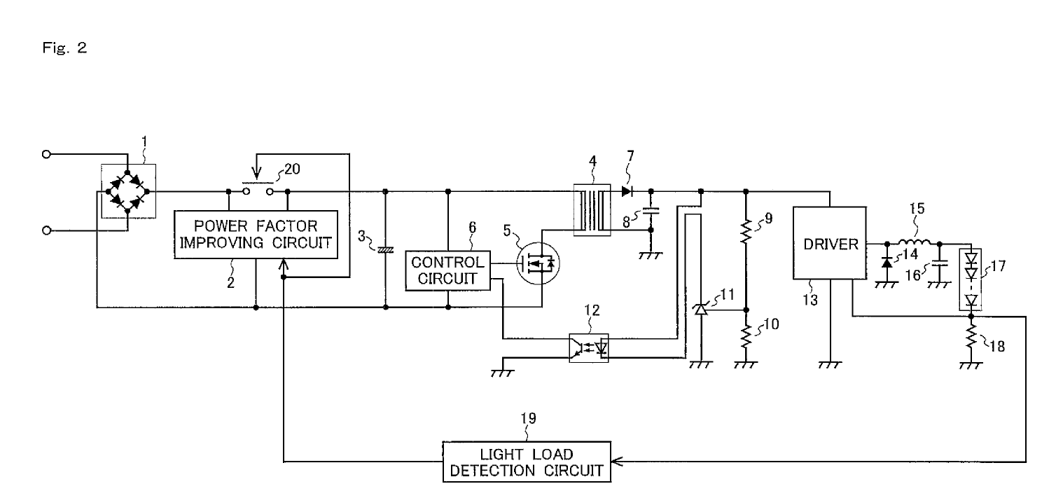

Next, the second embodiment of the invention will be described. FIG. 2 shows configuration of an illumination light emitting diode driving circuit according to the second embodiment of the invention. In FIG. 2, portions the same as those in FIG. 1 are provided with the same numerals and thus omitted from detailed description.

The illumination light emitting diode driving circuit according to the second embodiment of the invention has a relay 20 newly provided and connected in parallel to the power factor improving circuit 2 of the illumination light emitting diode driving circuit according to the first embodiment of the invention.

In this embodiment, as is the case with the first embodiment, a light load detection signal represents voltage drop at a current setting resistor 18, and is a signal in accordance with a current flowing through an illumination light emitting diode 17. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

In this embodiment, the power factor improving circuit 2, when the judgment result shows that the load is light, stops the operation to thereby reduce the power consumption in the power factor improving circuit 2. Moreover, the relay 20 receives the result of the judgment by the light load detection circuit 19, and turns on and bypasses the power factor improving circuit 2 at a stop when the judgment result shows that the load is light, and turns off and does not bypass the power factor improving circuit 2 when the judgment result shows that the load is not light.

In the illumination light emitting diode driving circuit according to the second embodiment of the invention, when the judgment result shows that the load is light, the power factor improving circuit 2 stops the operation, which permits suppressing the unnecessary power consumption. Moreover, while the operation of the power factor improving circuit 2 is stopped, the relay 20 turns on and bypasses the power factor improving circuit 2 at a stop, so that the illumination light emitting diode driving circuit according to the second embodiment of the invention operates as a whole without any problems.

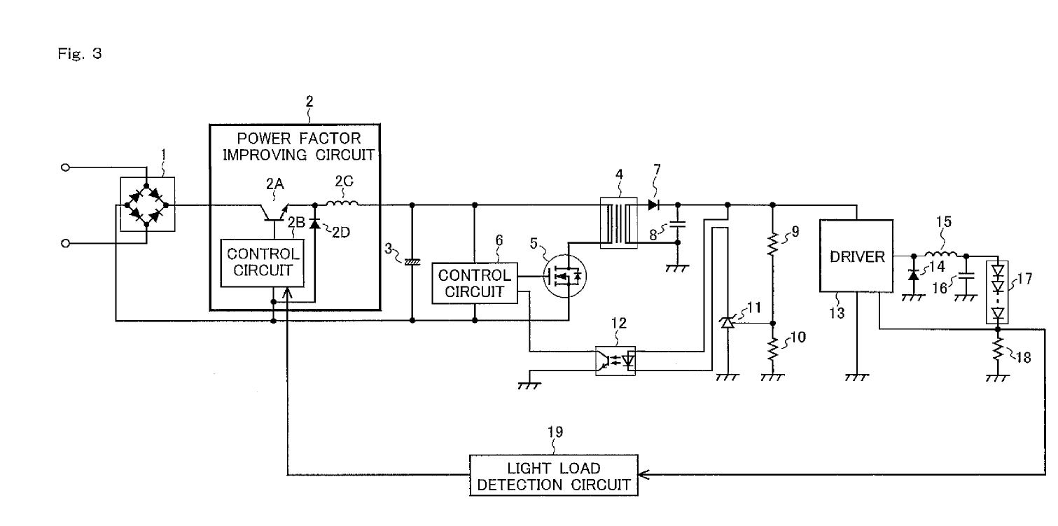

Next, the third embodiment of the invention will be described. FIG. 3 shows configuration of an illumination light emitting diode driving circuit according to the third embodiment of the invention. In FIG. 3, portions the same as those in FIG. 1 are provided with the same numerals and thus omitted from detailed description.

The illumination light emitting diode driving circuit according to the third embodiment of the invention has, in the power factor improving circuit 2 of the illumination light emitting diode driving circuit according to the first embodiment of the present invention, a switching transistor (NPN transistor) 2A, a control circuit 2B, a coil 2C, and a diode 2D.

In this embodiment, as is the case with the first embodiment, a light load detection signal represents voltage drop at a current setting resistor 18, and is a signal in accordance with a current flowing through an illumination light emitting diode 17. A light load detection circuit 19 compares the aforementioned light load detection signal with a preset threshold value, and judges that the load is light when the light load detection signal is smaller than the preset threshold value, and Judges that the load is not light when the light load detection signal is not smaller than the preset threshold value.

In this embodiment, the power factor improving circuit 2, when the judgment result shows that the load is light, the control circuit 2B performs series-control of the switching transistor 2A to thereby make the power consumption in the power factor improving circuit 2 lower than when the judgment result shows that the load is not light. When the judgment result shows that the load is not light, the control circuit 2B of the power factor improving circuit 2 performs switching-control of the switching transistor 2A.

In the illumination light emitting diode driving circuit according to the third embodiment of the invention, the power factor improving circuit 2 receives the result of the judgment by the light load detection circuit 19, and when the judgment result shows that the load is light, the control circuit 2B performs on the switching transistor 2A not the switching control, which is of the type less efficient when the load is light, but series control, which permits suppressing the unnecessary power consumption.

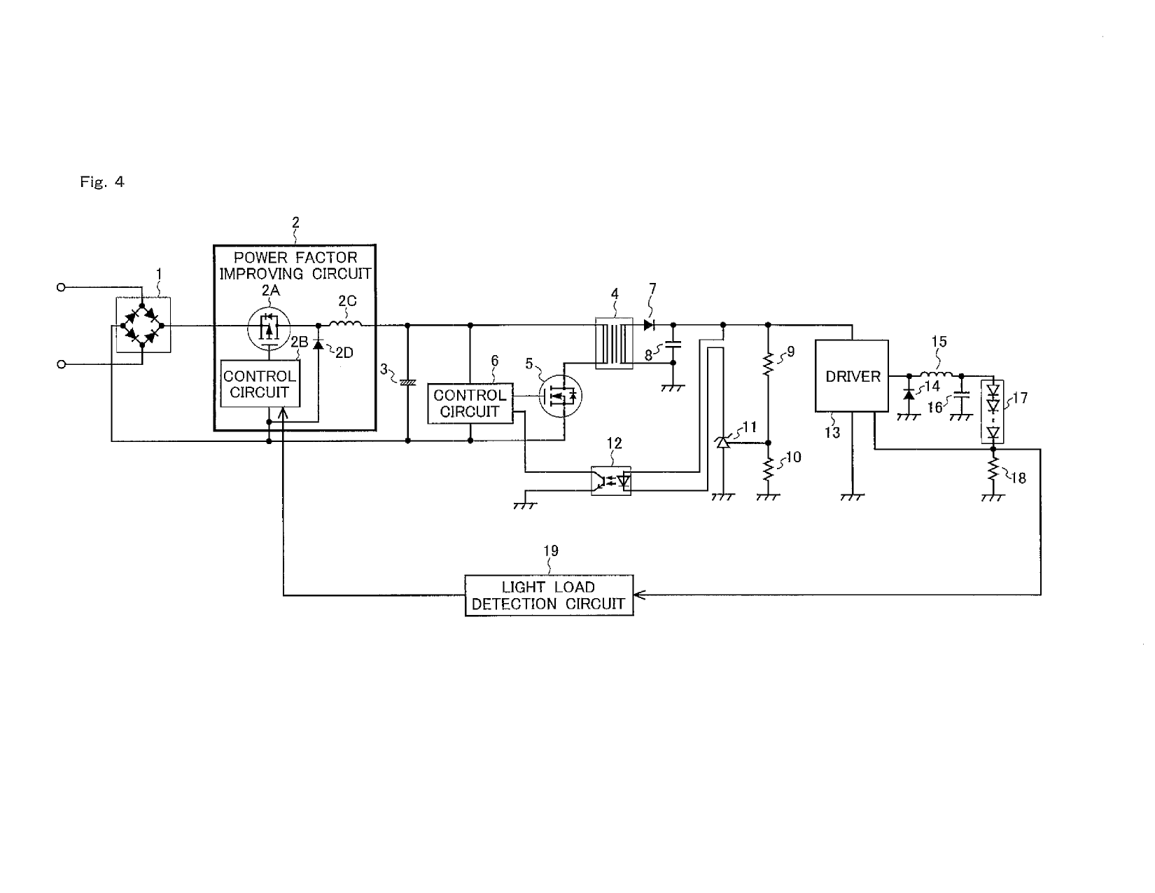

Next, the fourth embodiment of the invention will be described. FIG. 4 shows configuration of an illumination light emitting diode driving circuit according to the fourth embodiment of the invention. In FIG. 4, portions the same as those in FIG. 1 are provided with the same numerals and thus omitted from detailed description.

The illumination light emitting diode driving circuit according to the fourth embodiment of the invention has, in the power factor improving circuit 2 of the illumination light emitting diode driving circuit according to the first embodiment of the present invention, a switching transistor (N-channel MOSFET) 2A, a control circuit 2B, a coil 2C, and a diode 2D.

In this embodiment as is the case with the first embodiment, a light load detection signal represents voltage drop at a current setting resistor 18, and is a signal in accordance with a current flowing through an illumination light emitting diode 17. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

In this embodiment, in the power factor improving circuit 2, when the judgment result shows that the load is light, the control circuit 2B intermittently performs switching control of the switching transistor 2A to thereby lower the power consumption in the power factor improving circuit 2. When the judgment result shows that the load is not light, the control circuit 2B of the power factor improving circuit 2 constantly performs the switching control of the switching transistor 2A.

In the illumination light emitting diode driving circuit according to the fourth embodiment of the invention, the power factor improving circuit 2 receives the result of the judgment by the light load detection circuit 19, and when the judgment result shows that the load is light, the control circuit 2B intermittently performs the switching control of the switching transistor 2A, which permits suppressing the unnecessary power consumption.

Next, the fifth embodiment of the invention will be described. An illumination light emitting diode driving circuit according to the fifth embodiment of the invention has the same configuration, shown in FIG. 3, as the illumination light emitting diode driving circuit according to the third embodiment of the invention, but differs from the illumination light emitting diode driving circuit according to the third embodiment of the invention in operation of a control circuit 2B in a power factor improving circuit 2.

In this embodiment, as is the case with the third embodiment, a light load detection signal represents voltage drop at a current setting resistor 18, and is a signal in accordance with a current flowing through an illumination light emitting diode 17. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

In this embodiment, both when the judgment result shows that the load is light and when the judgment result shows that the load is not light, the control circuit 2B performs switching control of a switching transistor 2A. Then, when the judgment result shows that the load is light, as compared to when the judgment result shows that the load is not light, the switching frequency in the switching control is lowered to thereby lower the power consumption in the power factor improving circuit 2.

In the illumination light emitting diode driving circuit according to the fifth embodiment of the invention, the power factor improving circuit 2 receives the result of the judgment by the light load detection circuit 19, and when the judgment result shows that the load is light, the switching frequency of the switching control performed by the control circuit 2B on the switching transistor 2A is lowered, which permits suppressing the unnecessary power consumption.

Next, the sixth embodiment of the invention will be described. An illumination light emitting diode driving circuit according to the sixth embodiment of the invention has the same configuration, shown in FIG. 4, as the illumination light emitting diode driving circuit according to the fourth embodiment of the invention, but differs from the illumination light emitting diode driving circuit according to the fourth embodiment of the invention in operation of a control circuit 2B in a power factor improving circuit 2.

In this embodiment, as is the case with the fourth embodiment, a light load detection signal represents voltage drop at a current setting resistor 18, and is a signal in accordance with a current flowing through an illumination light emitting diode 17. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

In this embodiment, both when the judgment result shows that the load is light and when the judgment result shows that the load is not light, the control circuit 2B constantly performs switching control of a switching transistor 2A. Then, when the judgment result shows that the load is light, as compared to when the judgment result shows that the load is not light, the switching speed of the switching transistor 2A in the switching control is lowered to thereby make the power consumption in the power factor improving circuit 2 lower than power consumption during operation performed when the load is not light.

In the illumination light emitting diode driving circuit according to the sixth embodiment of the invention, the power factor improving circuit 2 receives the result of the judgment by the light load detection circuit 19, and when the judgment result shows that the load is light, the switching speed of the switching transistor 2A is reduced by the control circuit 2B, which permits suppressing the unnecessary power consumption. Examples of a method of reducing the switching speed of the switching transistor 2A include: a method of lowering a current level of a driving signal supplied from the control circuit 21 to a gate of the switching transistor 2A.

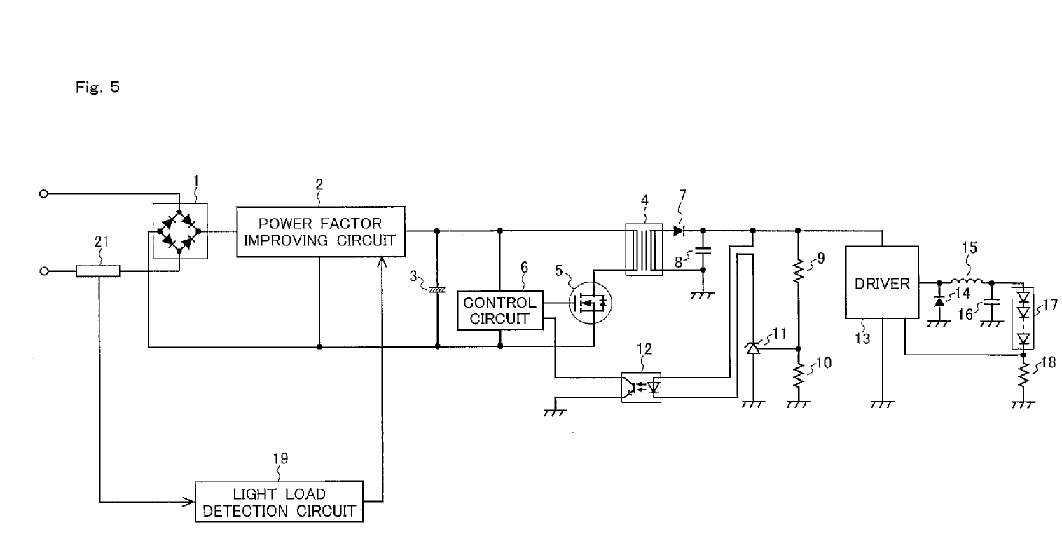

Next, the seventh embodiment of the invention will be described. FIG. 5 shows configuration of an illumination light emitting diode driving circuit according to the seventh embodiment of the invention. In FIG. 5, portions the same as those in FIG. 1 are provided with the same numerals and thus omitted from detailed description.

The illumination light emitting diode driving circuit according to the seventh embodiment of the invention has a current detection part 21 newly provided in the illumination light emitting diode driving circuit according to the first embodiment of the invention. This current detection part 21 detects a primary-side input AC current.

In this embodiment, unlike the first embodiment, a light load detection signal is a signal in accordance with a current detected by the current detection part 21. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

When the load is light, a harmonic current is small, which permits conformity with Class C of the higher harmonic wave regulations even without operating a power factor improving circuit normally. Thus, operating the power factor improving circuit normally when the load is light as in the conventional illumination light emitting diode driving circuit as shown in FIG. 9 results in unnecessary power consumption at the power factor improving circuit. On the other hand, in the illumination light emitting diode driving circuit according to the seventh embodiment of the invention, the power factor improving circuit 2 receives the result of the judgment by the light load detection circuit 19, and when the judgment result shows that the load is light, performs operation different from operation performed when the load is not light to thereby make the power consumption lower than power consumption during the operation performed when the load is not light, which permits suppressing the unnecessary power consumption.

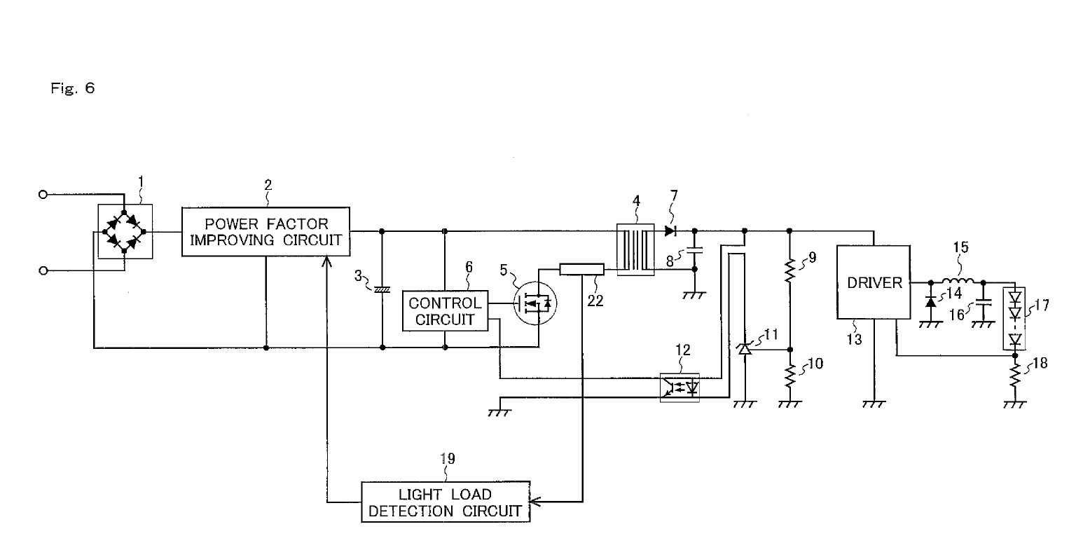

Next, the eighth embodiment of the invention will be described. FIG. 6 shows configuration of an illumination light emitting diode driving circuit according to the eighth embodiment of the invention. In FIG. 6, portions the same as those in FIG. 1 are provided with the same numerals and thus omitted from detailed description.

The illumination light emitting diode driving circuit according to the eighth embodiment of the invention has a current detection part 22 newly provided in the illumination light emitting diode driving circuit according to the first embodiment of the invention. This current detection part 22 detects a current flowing through an N-channel MOSFET 5.

In this embodiment, unlike the first embodiment, a light load detection signal is a signal in accordance with a current detected by the current detection part 22. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

When the load is light, a harmonic current is small, which permits conformity with Class C of the higher harmonic wave regulations even without operating a power factor improving circuit normally. Thus, operating the power factor improving circuit normally when the load is light as in the conventional illumination light emitting diode driving circuit as shown in FIG. 9 results in unnecessary power consumption at the power factor improving circuit. On the other band, in the illumination light emitting diode driving circuit according to the eighth embodiment of the invention, the power factor improving circuit 2 receives the result of the judgment by the light load detection circuit 19, and when the judgment result shows that the load is light, performs operation different from operation performed when the load is not light to thereby make the power consumption lower than power consumption during the operation performed when the load is not light, which permits suppressing the unnecessary power consumption.

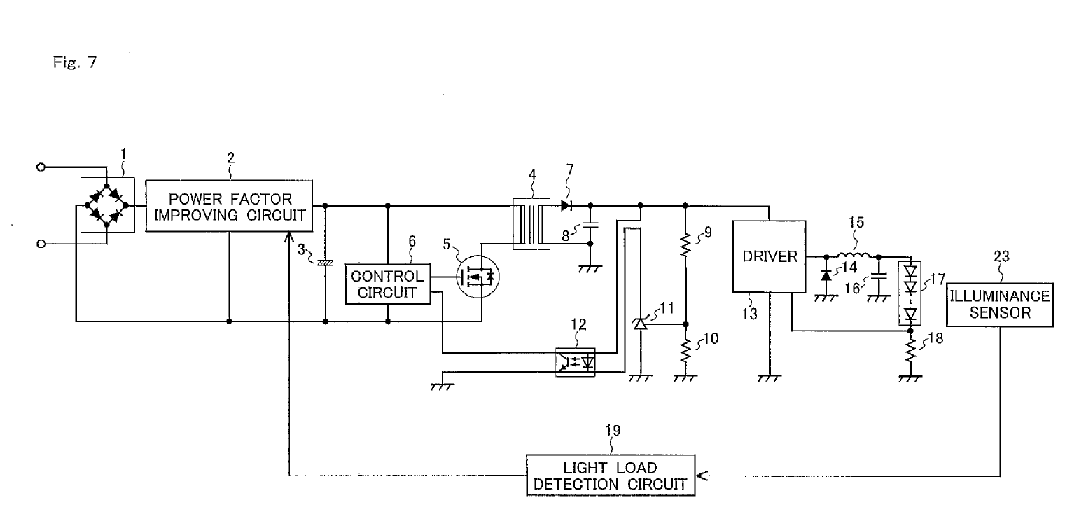

Next, the ninth embodiment of the invention will be described. FIG. 7 shows configuration of an illumination light emitting diode driving circuit according to the ninth embodiment of the invention. In FIG. 7, portions the same as those in FIG. 1 are provided with the same numerals and thus omitted from detailed description.

The illumination light emitting diode driving circuit according to the ninth embodiment of the invention has a illuminance sensor 23 newly provided in the illumination light emitting diode driving circuit according to the first embodiment of the invention. This illuminance sensor 23 detects the amount of light of an illumination light emitting diode 17.

In this embodiment, unlike the first embodiment, a light load detection signal is a signal in accordance with the amount of light of the illumination light emitting diode 17 detected by the illuminance sensor 23. A light load detection circuit 19 compares the aforementioned light load detection signal with a preset threshold value, and judges that the toad is light when the light load detection signal is smaller than the preset threshold value, and judges that the load is not light when the light load detection signal is not smaller than the preset threshold value.

When the load is light, a harmonic current is small, which permits conformity with Class C of the higher harmonic wave regulations even without operating a power factor improving circuit normally. Thus, operating the power factor improving circuit normally when the load is light as in the conventional illumination light emitting diode driving circuit as shown in FIG. 9 results in unnecessary power consumption at the power factor improving circuit. On the other hand, in the illumination light emitting diode driving circuit according to the ninth embodiment of the invention, the power factor improving circuit 2 receives the result of the judgment by the light load detection circuit 19, and when the judgment result shows that the load is light, performs operation different from operation performed when the load is not light to thereby make the power consumption lower than power consumption during the operation performed when the load is not light, which permits suppressing the unnecessary power consumption.

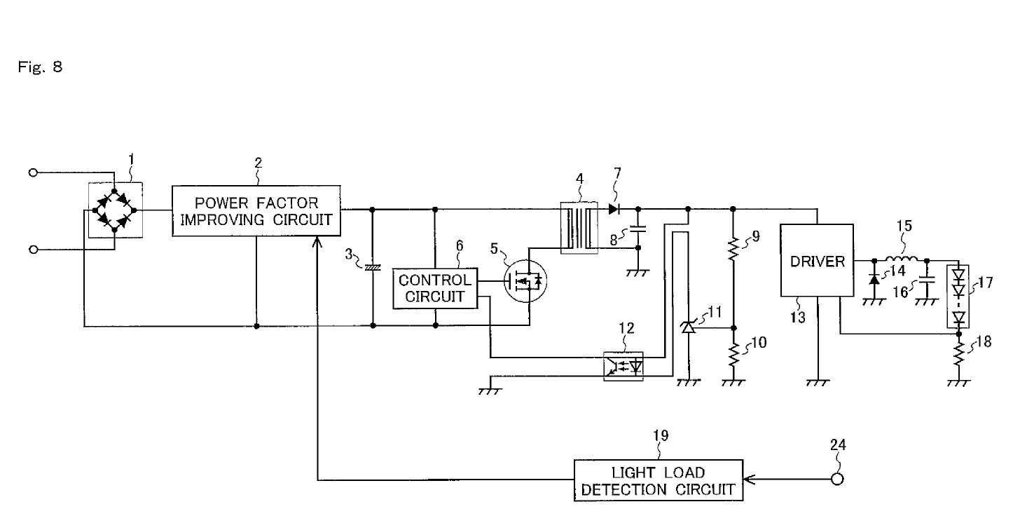

Next, the tenth embodiment of the invention will be described. FIG. 8 shows configuration of an illumination light emitting diode driving circuit according to the tenth embodiment of the invention. In FIG. 8, portions the same as those in FIG. 1 are provided with the same numerals and thus omitted from detailed description.

The illumination light emitting diode driving circuit according to the tenth embodiment of the invention has an external signal input terminal 24 newly provided in the illumination light emitting diode driving circuit according to the first embodiment of the invention. This external signal input terminal 24 is provided for inputting an external signal.

In this embodiment, unlike the first embodiment, a light load detection signal is a signal in accordance with an external signal outputted from a microcomputer or the like and received by the external input terminal 24. A light load detection circuit 19 compares the aforementioned light load detection signal with a preset threshold value, and judges that the load is light when the light load detection signal is smaller than the preset threshold value, and judges that the load is not light when the light load detection signal is not smaller than the preset threshold value.

When the load is light, a harmonic current is small, which permits conformity with Class C of the higher harmonic wave regulations even without operating a power factor improving circuit normally. Thus, operating the power factor improving circuit normally when the load is light as in the conventional illumination light emitting diode driving circuit as shown in FIG. 9 results in unnecessary power consumption at the power factor improving circuit. On the other hand, in the illumination light emitting diode driving circuit according to the tenth embodiment of the invention, the power factor improving circuit 2 receives the result of the judgment by the light load detection circuit 19, and when the judgment result shows that the load is light, performs operation different from operation performed when the load is not light to thereby make the power consumption lower than power consumption during the operation performed when the load is not light, which permits suppressing the unnecessary power consumption.

Loading any of the aforementioned illumination light emitting diode driving circuits according to the invention in a light emitting diode illumination device permits achieving a light emitting diode illumination device that suppresses unnecessary power consumption.

The above embodiments have been described, referring to a case where an illumination light emitting diode is used as an illumination light emitting element. Note that the illumination light emitting element driving circuit according to the invention may be, for example, a circuit for driving an illumination organic EL.

What is claimed is:

1. An illumination light emitting element driving circuit comprising a power factor improving circuit,
wherein the power factor improving circuit, when a load of the illumination light emitting element driving circuit is light, performs operation (including stopping the operation) different from operation performed when the load of the illumination light emitting element driving circuit is not light to thereby lower power consumption.

2. The illumination light emitting element driving circuit according to claim 1, further comprising a bypass part bypassing the power factor improving circuit when the load of the illumination light emitting element driving circuit is light.
wherein the power factor improving circuit stops the operation when the load of the illumination light emitting element driving circuit is light.

3. The illumination light emitting element driving circuit according to claim 1,
wherein the power factor improving circuit includes:
a switching transistor; and
a control circuit performing series control of the switching transistor when the load of the illumination light emitting element driving circuit is light and performing switching control of the switching transistor when the load of the illumination light emitting element driving circuit is not light.

4. The illumination light emitting element driving circuit according to claim 1,
wherein the power factor improving circuit includes:
a switching transistor; and
a control circuit intermittently performing switching control of the switching transistor when the load of the illumination light emitting element driving circuit is light and constantly performing the switching control of the switching transistor when the load of the illumination light emitting element driving circuit is not light.

5. The illumination light emitting element driving circuit according to claim 1,
wherein the power factor improving circuit comprises.
a switching transistor; and
a control circuit, when the load of the illumination light emitting element driving circuit is light, as compared to when the load of the illumination light emitting element driving circuit is not light, lowering a switching frequency in switching control of the switching transistor.

6. The illumination light emitting element driving circuit according to claim 1,
wherein the power factor improving circuit comprises:
a switching transistor; and
a control circuit, when the load of the illumination light emitting element driving circuit is light, as compared to when the load of the illumination light emitting element driving circuit is not light, lowering a switching speed of the switching transistor in switching control of the switching transistor.

7. The illumination light emitting element driving circuit according to claim 1, further comprising a judgment part detecting a current flowing through the load of the illumination light emitting element driving circuit and judging whether or not the load of the illumination light emitting element driving circuit is light,
wherein the power factor improving circuit performs operation (including stopping the operation) in accordance with a result of the judgment by the judgment part.

8. The illumination light emitting element driving circuit according to claim 1, comprising:
a constant voltage output switching power supply circuit of an AC input type having the power factor improving circuit and a switching element, the constant voltage output switching power supply circuit outputting a predetermined DC voltage by duty control of the switching element; and
a constant current output switching power supply circuit supplying a constant current to an illumination light emitting element by using the voltage outputted by the constant voltage output switching power supply circuit as a driving voltage,
the illumination light emitting element driving circuit further comprising a judgment part detecting an input AC current of the constant voltage output switching power supply circuit and judging whether or not the load of the illumination light emitting element driving circuit is light,
wherein the power factor improving circuit performs operation (including stopping the operation) in accordance with a result of the judgment by the judgment part.

9. The illumination light emitting element driving circuit according to claim 1, comprising:
a constant voltage output switching power supply circuit of an AC input type having the power factor improving circuit and a switching element, the constant voltage output switching power supply circuit outputting a predetermined DC voltage by duty control of the switching element; and
a constant current output switching power supply circuit supplying a constant current to an illumination light emitting element by using the voltage outputted by the constant voltage output switching power supply circuit as a driving voltage,
the illumination light emitting element driving circuit further comprising a judgment part detecting a current flowing through the switching element and judging whether or not the load of the illumination light emitting element driving circuit is light,
wherein the power factor improving circuit performs operation (including stopping the operation) in accordance with a result of the judgment by the judgment part.

10. The illumination light emitting element driving circuit according to claim 1, further comprising a judgment part detecting an amount of light of the load of the illumination light emitting element driving circuit and judging whether or not the load of the illumination light emitting element driving circuit is light,
wherein the power factor improving circuit performs operation (including stopping the operation) in accordance with a result of the judgment by the judgment part.

11. The illumination light emitting element driving circuit according to claim 1, further comprising a judgment part receiving an external signal and judging based on the external signal whether or not the load of the illumination light emitting element driving circuit is light,
wherein the power factor improving circuit performs operation (including stopping the operation) in accordance with a result of the judgment by the judgment part.

12. An illumination device comprising an illumination light emitting element driving circuit,
wherein the illumination light emitting element driving circuit is an illumination light emitting element driving circuit comprising a power factor improving circuit,
wherein, when a load of the illumination light emitting element driving circuit is light, the power factor improving circuit performs different operation (including stopping the operation) different from operation performed when the load of the illumination light emitting element driving circuit is not light to thereby lower power consumption.
